(19) United States
(12) Patent Application Publication
(10) Pub. No.: US 2014/0226906 A1
(43) Pub. Date: Aug. 14, 2014

(54) IMAGE MATCHING METHOD AND APPARATUS

(71) Applicant: SAMSUNG ELECTRONICS CO., LTD., Gyeonggi-do (KR)

(72) Inventor: Woo-Sung KANG, Gyeonggi-do (KR)

(73) Assignee: Samsung Electronics Co., Ltd., Gyeonggi-do (KR)

(21) Appl. No.: 13/767,340

(22) Filed: Feb. 14, 2013

(30) Foreign Application Priority Data
Feb. 13, 2013 (KR) 10-2013-0015435

(51) Int. Cl. G06K 9/62

(52) U.S. Cl. CPC G06K 9/6202
USPC 382/197; 382/201

(57) ABSTRACT

Methods and apparatus are provided for image matching. A first image is received via an external input. One or more feature points are extracted from the first image. One or more descriptors are generated for the first image based on the one or more feature points. The first image is matched with a second image by comparing the one or more descriptors for the first image with one or more descriptors for the second image.

### PRIORITY

This application claims priority under 35 U.S.C. §119(a) to a Korean Patent Application field in the Korean Intellectual Property Office on Feb. 13, 2013, and assigned Serial No. 10-2013-0015435, the entire disclosure of which is incorporated herein by reference.

### BACKGROUND OF THE INVENTION

1. Field of the Invention

The present invention relates generally to an image matching method and apparatus, and more particularly, to an image matching method and apparatus that can increase processing speed by reducing an amount of computation while more clearly representing characteristics of an image to be matched image.

2. Description of the Related Art

Feature matching technology finds matching points between images that include the same scene from different viewpoints. Feature matching is applied in various image-processing fields, such as, for example, object recognition, three-dimensional reconstruction, stereo vision, panorama generation, robot position estimation, etc. With enhanced computational performance of mobile devices, image processing, such as, for example, mobile augmented reality and/or image searching through the feature matching, has become more requested. Studies on an algorithm are being conducted that would enable a mobile device to perform accurate computation in real time for fast image processing.

Image matching technology includes a feature extraction stage for extracting feature points, a feature description stage for describing feature points from neighboring image patch information, a feature matching stage for obtaining a matching relationship between images by comparing descriptors of the described feature points and descriptors for any other image, and an outlier removal stage for removing wrong-matched feature point pairs.

An algorithm most widely used in the feature extraction stage is a Scale Invariant Feature Transform (SIFT) algorithm. The SIFT algorithm is used to extract feature points robust against affine transformation and describe the extracted features in gradient histograms of brightness. The SIFT algorithm is relatively robust against viewpoint changes when compared with other algorithms. However, when the mobile device performs image processing with the SIFT algorithm, a floating point operation should be performed to obtain the gradient histogram of feature descriptors extracted from images. Furthermore, when image processing with the SIFT algorithm, a transcendental function often needs to be called, which increases the amount of computation, thus slowing down the processing speed.

In order to supplement the shortcomings of the SIFT algorithm, a Speeded Up Robust Features (SURF) algorithm has been suggested in order to improve the processing speed by taking advantage of integral images and using box filters to approximate an effect of the SIFT algorithm. In comparison with the SIFT algorithm, the SURF algorithm performs computation three times faster while providing similar performance in rotation and resizing. However, it is also difficult to apply the SURF algorithm to mobile devices, except for personal computers, because of floating point operations.

Recently, a feature matching technique using Random Ferns, which is a type of Random Trees, has been suggested. The feature matching technique is advantageous in that it is robust against viewpoint changes by resolving a problem of nearest neighbor search with a classification. However, the feature matching technique using Random Ferns is not suitable to be applied for mobile devices since Random Ferns requires a large amount of memory capacity to classify respective local feature descriptor vectors.

### SUMMARY OF THE INVENTION

The present invention has been made to address at least the above problems and/or disadvantages and to provide at least the advantages described below. Accordingly, an aspect of the present invention provides an image matching method and apparatus that can increase processing speed by reducing an amount of computation while more clearly representing characteristics of a matched image.

In accordance with an aspect of the present invention, an image matching apparatus is provided, which includes an image input unit for receiving a first image, and a feature extractor for extracting one or more feature points from the first image. The image matching apparatus also includes a descriptor generator for generating one or more descriptors for the first image based on the one or more feature points. The image matching apparatus further includes an image matcher for matching the first image with a second image by comparing the one or more descriptors for the first image with one or more descriptors for the second image.

In accordance with another aspect of the present invention, an image matching method is provided. A first image is received via an external input. One or more feature points are extracted from the first image. One or more descriptors are generated for the first image based on the one or more feature points. The first image is matched with a second image by comparing the one or more descriptors for the first image with one or more descriptors for the second image.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a block diagram illustrating an image matching apparatus, according to an embodiment of the present invention;

FIG. 2 is a diagram illustrating data projections according to binary hash functions, according to an embodiment of the present invention;

FIG. 3 illustrates an example of obtaining a descriptor represented as binary data from an image patch in case of k=2 in Equation (1), according to an embodiment of the present invention;

FIG. 4 illustrates an example of rotation normalization of an image patch in a dominant orientation, according to an embodiment of the present invention;

FIG. 5 illustrates hash tables with a plurality of hash keys generated from local feature descriptor vectors, according to an embodiment of the present invention;

FIG. 6 is a flowchart illustrating an image matching method in the image matching apparatus of FIG. 1, according to an embodiment of the present invention;

FIG. 7 is a flowchart illustrating descriptor generation of the image matching method in the image matching apparatus of FIG. 1, according to an embodiment of the present invention;

FIGS. 8A and 8B illustrate image patches with which to generate descriptors in the image matching apparatus of FIG. 1, according to an embodiment of the present invention;

FIG. 9A illustrates an image patch in which m pairs of opposite vectors centered at a feature point are represented in a counterclockwise direction in order to estimate a dominant orientation of the feature point, according to an embodiment of the present invention;

FIG. 9B illustrates how to obtain the dominant orientation of the feature point within the image patch by calculating a sum of m pairs of vectors, according to an embodiment of the present invention;

FIG. 10 illustrates a process of obtaining a descriptor that corresponds to a feature point through normalization of an image patch when the angle of the image patch has been calculated as in FIG. 9B, according to an embodiment of the present invention;

FIG. 11A illustrates an image patch being counter-rotated in the opposite orientation of the dominant orientation for rotation normalization of the image patch, according to an embodiment of the present invention;

FIG. 11B illustrates positions of points for brightness comparison for image descriptors being relatively rotated instead of rotating the image patch, leading to the same effect as in FIG. 11A, according to an embodiment of the present invention;

FIG. 12 is a diagram illustrating discernability between feature vectors in an image matcher, according to an embodiment of the present invention; and

FIG. 13 illustrates an example of data searching with hash keys, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

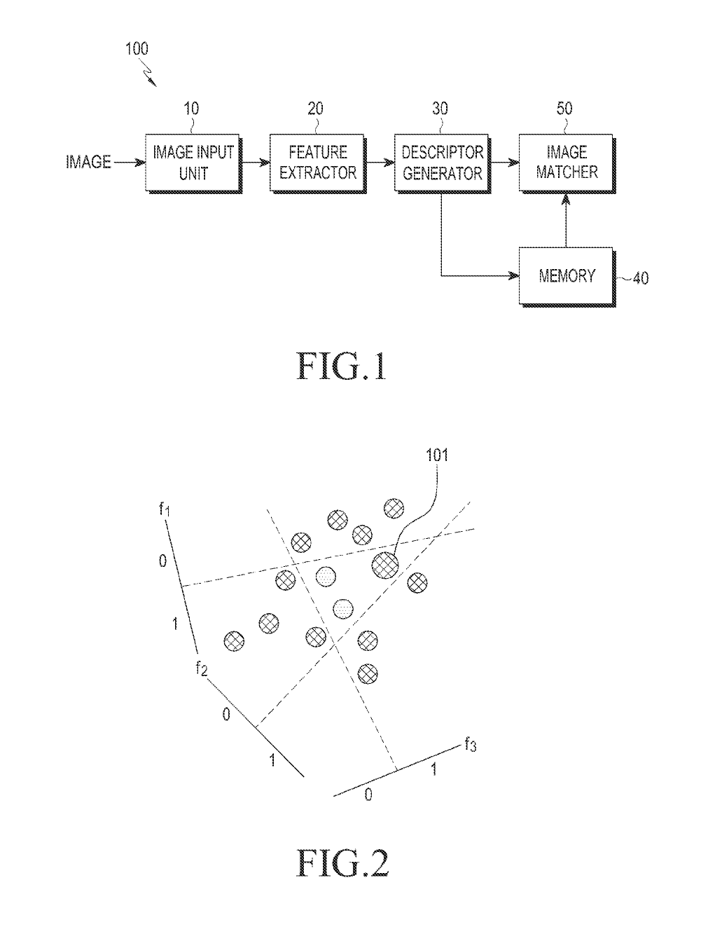

FIG. 1 is a block diagram illustrating an image matching apparatus, according to an embodiment of the present invention.

Referring to FIG. 1, an apparatus 100 includes an image input unit 10, a feature extractor 20, a descriptor generator 30, a memory 40, and an image matcher 50.

The image input unit 10 receives an image to be image-matched and outputs the image to the feature extractor 20. In an embodiment of the present invention, the image 10 input unit 10 may receive the image from a camera connected to the image matching apparatus 100.

The feature extractor 20 extracts feature points from the image passed on from the image input unit 10. In an embodiment of the present invention, the feature points extracted by the feature extractor 20 may be stored in the memory 40.

The feature extractor 20 may repetitively extract the feature points from the image passed on from the image input unit 10 even when there has been a geometric change, such as, for example, the image having been rotated or having changed in size.

In an embodiment of the present invention, the feature extractor 20 may quickly extract feature points using a Feature from Accelerated Segment Test (FAST) corner detection scheme. The FAST corner detection scheme compares an arbitrary point in the image with 16 neighboring pixels in terms of brightness. With the FAST corner detection scheme, the feature extractor 20 first compares brightness of a reference point with a brightness of each neighboring pixel. If more than 10 consecutive neighboring pixels are brighter than the reference point by a predetermined threshold, the feature extractor 20 classifies the reference point as a ‘corner’ point. In this embodiment of the present invention, while the feature extractor 20 extracts feature points according to the FAST corner detection scheme, it will be obvious to one of ordinary skill in the art that feature points may be extracted according to schemes other than the FAST corner detection scheme.

The descriptor generator 30 generates a descriptor that corresponds to the whole or a part of the image input through the image input unit 10. The descriptor generator 30 generates descriptors, especially local feature descriptors corresponding to the feature points of the image. In an embodiment of the present invention, the descriptors generated by the descriptor generator 30 may be stored in the memory 40.

Since the FAST corner detection scheme performs operations without taking an input image, in particular, the size of the image, into account, its repetitive detection performance against a change in size of the image is relatively lower than that of the SIFT algorithm and the SURF algorithm. Thus, the descriptor generator 30 may generate a descriptor corresponding to the whole or a part of an image input through the image input unit 10 by applying an image pyramid structure to the whole or a part of the image. When the image pyramid structure is applied, an image on a neighboring layer may be obtained by reducing an image of a current layer with 1/\sqrt{2} magnifications. Herein, an image to be used for application of the image pyramid structure is referred to as a “learning image”.

The descriptor generator 30 may shorten the time required for the image matcher 50 to perform a matching operation by designing a local feature descriptor applicable to a Locality Sensitive Hashing (LSH) technique. The descriptor generator 30 represents the value of the local feature descriptor obtained from the feature point in a binary form, i.e., as binary data. The binary data in which the local feature descriptor is represented is easy for later calculation of a hash key. A function that converts image patches into binary data is expressed in Equation (1) below:

$${S}_{r} ( x ) = \{ \begin{matrix}1 , & if {p}_{r}^{T} x \geq 0 \\ 0 , & otherwise\end{matrix} \qquad ( 1 )$$

x is a column vector ‘(nn)×1’ converted from a square matrix ‘n×n’ of an image patch, and p is a projection vector represented with ‘−1’, ‘0’, or ‘1’. In the projection vector p, the number of each of “1's” and “−1's” is k (a natural number), which is ‘(nn)>>k’. Positions of “1′s” and “−1's” in the projection vector p may be randomly selected, and most of the elements of the projection vector p may be “0's”.

The image matcher 50 matches two images by comparing a descriptor of an image generated by the descriptor generator 30 with a descriptor of any other image stored in the memory 40.

The image matcher 50 may employ, e.g., the LSH technique, to compare descriptors generated by the descriptor generator 30 or find any other descriptor similar to the descriptor generated by the descriptor generator 30.

The LSH technique is an algorithm that searches in a space of the Hamming distance for data in binary (binary data). Given query data, the LSH technique obtains a hash code by projecting the query data onto a lower dimensional binary (Hamming) space, and then calculates a hash key by using the hash code. The ‘query data’ refers to e.g., at least a part of an image newly input through the image input unit 10, which is to be used to calculate the hash key using a predetermined hash table.

Once the hash key is calculated, the LSH technique linearly searches data stored in buckets that correspond to respective hash keys to determine the most similar data. There may be a number of hash tables used to calculate the hash key in the LSH technique, and the query data may have as many hash keys as the number of hash tables. In an embodiment of the present invention, if n (a natural number) dimensional vector data is to be searched, the hash key may be a b (a natural number) dimensional binary vector, where b is less than n, and the binary vector may be calculated according to b binary hash functions.

A binary hash function is used, as shown in Equation (2) below, to convert vector data x to binary data with a value “0” or “1” through projection, and b-bit binary vector may be projected from b different projection functions.

$${h}_{r} ( x ) = \{ \begin{matrix}1 , & if {r}^{T} x \geq 0 \\ 0 , & otherwise\end{matrix} \qquad ( 2 )$$

FIG. 2 is a diagram illustrating data projection according to binary hash functions, according to an embodiment of the present invention. Referring to FIG. 2, the image matcher 50 selected an arbitrary point from among a data set of points. The arbitrary point selected by the image matcher 50 may be projected by, e.g., 3 arbitrarily selected binary hash functions f₁, f₂, and f₃, onto 3-bit vector data 101. The projected selected point becomes ‘1’ by the binary hash function f₁, ‘0’ by f₂, and ‘1’ by f₃. Thus, the selected point is projected onto 3-bit vector data ‘101’ by the three binary hash functions f₁, f₂, and f₃.

When given a large amount of data, the LSH technique groups all the data by hash key values by storing it in a corresponding bucket vectors having a hash key value generated according to a predetermined hash key function in a learning stage. With the LSH technique, given the query data, the image matching apparatus 100 obtains a predetermined number of hash key values by using the hash table. Also, the image matching apparatus 100 may quickly find similar data by determining a similarity between hash key values only within the data set stored in buckets corresponding to the hash key values, respectively.

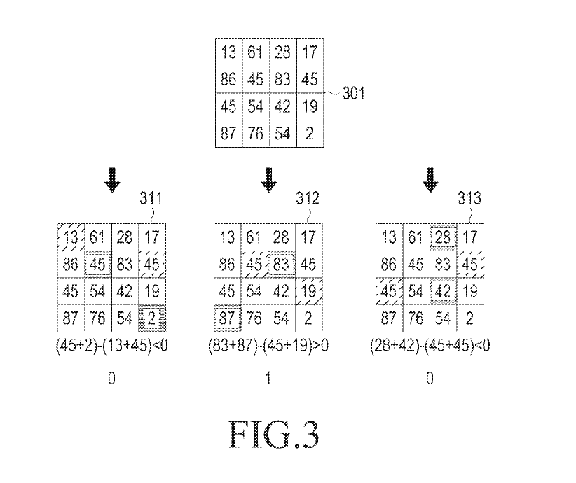

FIG. 3 illustrates an example of obtaining a descriptor represented as binary data from an image patch when k=2 in Equation (1), according to an embodiment of the present invention.

In FIG. 3, in order to obtain a 256 dimensional local feature descriptor, it is assumed that the descriptor generator 30 has already obtained 256 projection vectors. The image matching apparatus 100 may determine an image patch by projecting a neighboring image patch if a corner point is obtained. The actual image patch is assumed to be a ‘31×31’ size in FIG. 3, and the image matching apparatus 100 may perform Gaussian filtering on the image patch before generating the local feature descriptor.

Given the image to be learned as in FIG. 3, the image matching apparatus 100 converts the image to be reduced with a scaling factor for each level to generate a number of pyramid images, and calculates descriptors for feature points corresponding to respective pyramid images. Positions of points corresponding to respective local feature descriptors and the pyramid image's scale may be stored together in the memory 40.

Referring to FIG. 3, the descriptor generator 30 obtained a local feature descriptor ‘010’ by projecting three projection vectors onto the image patch 301. In the process of obtaining the local feature descriptor ‘101’, the descriptor generator 30 arbitrarily selects two pairs of points in the image patch 301 and compares their brightness. It is assumed that numbers written in the image patch 301 are brightness values for respective pixels. For example, in the first image patch 311, a pixel having a brightness 45 is compared with a pixel having a brightness 13, and a pixel having a brightness 2 is compared with a pixel having a brightness 45. The descriptor generator 30 obtains ‘(45−13)+(2−45)=(45+2)−(13+45)=(−11)’ for a brightness value of a first image patch 311. The brightness value of the first image patch 311 is less than 0, so the value resulting from projection of the first image patch 311 becomes 0. In FIG. 3, ‘1’ and ‘0’ are obtained by projecting respective projection vectors onto a second image patch 312 and a third image patch 313, in the same way as for the first image patch 311. Thus, a descriptor for the image patch 301 of FIG. 3 becomes ‘010’.

Prior to generating the descriptor, the descriptor generator 30 may normalize the image patch for rotation. First, the descriptor generator 30 obtains a dominant orientation around the extracted feature points. In an embodiment of the present invention, the dominant orientation may be obtained from an image gradient histogram of image patches. The descriptor generator 30 performs rotation normalization on the image patch centering at a feature point, and may obtain the local feature descriptor from the rotation normalized image patch.

In a conventional process of obtaining a gradient of a feature vector, the image matching apparatus 100 requires a large amount of operations since it has to do arctangent, cosine, or sine operations for each pixel. To reduce the amount of operations, the SURF algorithm may utilize an integral image and a box filter to approximate the rotation normalization. However, even with the SURF algorithm, when the image rotated by a multiple of 45 degrees, an error occurs in the normalization process and the operation speed for calculation of the gradient of the feature vector is not significantly increased.

To solve the above-described problem, embodiments of the present invention suggests a method by which to estimate dominant orientation of an image patch more simply and quickly than the SURF algorithm, and to normalize the image patch in the estimated dominant orientation. The rotating method, according to an embodiment of the present invention, does not need to measure the accurate dominant orientation from all gradients of the image patch. The rotating method is simple since it reconstructs the image patch from an angle by which the image patch was rotated, back to an original angle.

For example, if an image patch centered at a feature point c is given, a vector of the angle of rotation may be obtained as follows. I(P₁) and I(P₂) are assumed to be brightness values at feature points P₁ and P₂, respectively. A vector dI(P₁, P₂) for brightness change at feature points P₁ and P₂ may be obtained as shown below in Equation (3).

$$dI ( {P}_{1} , {P}_{2} ) = \frac{I ( {P}_{1} ) - I ( {P}_{2} )}{\sqrt{{( {x}_{1} - {x}_{2} )}^{2} + {( {y}_{1} - {y}_{2} )}^{2}}} ( {x}_{1} - {x}_{2} , {y}_{1} - {y}_{2} ) \qquad ( 3 )$$

x₁, x₂, y₁, y₂ are x, y coordinates of P₁ and P₂, respectively. Also, the orientation of dI(P₁, P₂) corresponds to a normal vector of a straight line passing from P₁ to P2, and the scalar of dI(P₁, P₂) corresponds to a difference in brightness between the two positions. The angle of rotation of the image patch at the feature point c may be obtained as shown in Equation (4) from the vector for brightness change in Equation (3).

$$θ ( c ) = arctan ( {\sum }_{{P}_{i} , {P}_{j} ∈ W ( c )}^{ } dI ( {P}_{i} , {P}_{j} ) ) \qquad ( 4 )$$

Pᵢ and Pⱼ are positions of points belonging to an image patch W(c) centered at a position of the feature point c. A pair of positions of Pᵢ and Pⱼ used for obtaining the angle of rotation may be defined in advance before image learning. The pair may be selected based on when the distance between the two points becomes more than ½ of the width of the image patch.

In this embodiment of the present invention, positions of 8 pairs of points are stored beforehand and used in the calculation of the angle of rotation of a feature point in the dominant orientation when the feature point is extracted. Once the dominant orientation of the image patch is obtained, the descriptor generator 30 rotates the image patch in an opposite orientation of the angle of rotation, before generating the descriptor from the image patch. When rotating the image patch in the opposite orientation, many pixels have to be moved. Thus, instead of rotating the image patch, positions of “−1's” and “1's” in a projection vector 421 for binary representation as predetermined in Equation (1) may be rotated around the center c.

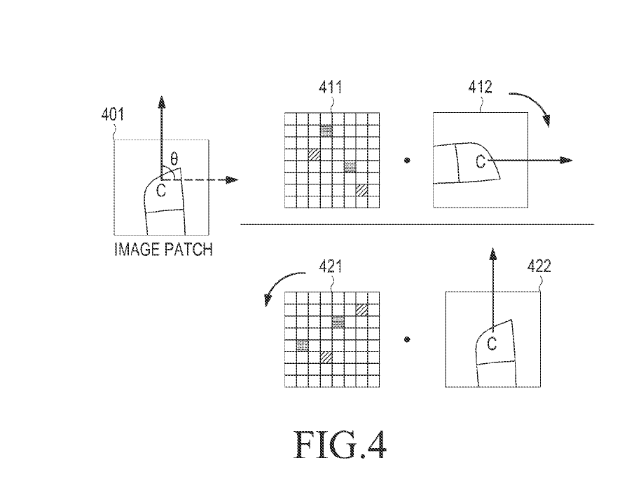

FIG. 4 illustrates an example of rotation normalization of an image patch in a dominant orientation, according to an embodiment of the present invention. Referring to FIG. 4, when an image patch 401 is to be rotated using a conventional random projection vector 411, the image patch 401 becomes a rotation normalized image patch 412 by rotating the image patch 401 in a dominant orientation, i.e., rotating the image patch 401 around a point c.

In an embodiment of the present invention, however, rotation normalization is performed on the original image patch 401 by rotating a rotation normalized projection vector 421 instead of the original image patch 401, around the feature point c. In this embodiment of the present invention, the descriptor generator 30 performs the rotation normalization on positions of “−1's” and “1's” of the projection vector 421 by rotating them around the feature point c. Thus, as seen from the lower part of FIG. 4, the image patch 422 to which the random projection vector 421 is applied may appear to be the same as the original image patch 401.

The image matcher 50 matches two images by comparing descriptors of an image generated by the descriptor generator 30 with descriptors of any other image stored in the memory 40. As described above, an image patch input through the image input unit 10 and included in an image from which a descriptor is generated by the descriptor generator 30 is called a ‘first image patch’, and an image patch included in an image stored in the memory 40 is called a ‘second image patch’. The image matcher 50 may match images by comparing a descriptor for the first image patch with a descriptor for the second image patch.

In an embodiment of the present invention, in the process of comparing the descriptor for the first image patch with the descriptor for the second image patch, the image matcher 50 may employ, e.g., the LSH technique.

The LSH technique is an algorithm for searching in a space of the Hamming distance for data in binary representation. If a query data is given, the LSH technique obtains a hash code by performing data projection of the query data onto a lower dimensional binary (Hamming) space, and then calculates a hash key using the hash code. The ‘query data’ refers to, e.g., at least a part of the first image newly input through the image input unit 10, which is to be used to calculate the hash key using a predetermined hash table.

Once the hash key is calculated, the LSH technique linearly searches data stored in buckets that correspond to respective hash keys to find out the most similar data. There may be a number of hash tables used to calculate hash keys in the LSH technique, and the query data may have as many hash keys as the number of hash tables. In an embodiment of the present invention, if n (a natural number) dimensional vector data is to be searched, the hash key may be a b (a natural number) dimensional binary vector, where b is less than n, and the binary vector may be calculated according to b binary hash functions.

The binary hash function is used as shown in Equation (5) below to convert vector data x to binary data with a value “0” or “1” through projection, and b-bit binary vector may be projected from b different projection functions.

$${h}_{r} ( x ) = \{ \begin{matrix}1 , & if {r}^{T} x \geq 0 \\ 0 , & otherwise\end{matrix} \qquad ( 5 )$$

Once comparison between descriptors is performed as described above, the image matcher 50 may know a matching relationship between the first image patch and the second image patch. The image matcher 50 may then presume a conversion solution to convert the first image patch to the second image patch or convert the second image patch to the first image patch.

Given, for example, the query data, which is an input image, to be recognized by the image matching apparatus 100, the image matcher 50 identifies the most similar image by comparing a set of local feature descriptors of the query data with a set of local feature descriptors of learned images.

The image matcher 50 may determine an image having the greatest number of feature points matched with feature points of the query data as a candidate for the most similar image, i.e., a candidate image. The image matcher 50 may then examine whether the candidate image is substantially effective in geometry through Homography estimation using the RANdom SAmple Consensus (RANSAC) algorithm.

As images to be recognized in linear searching for determining the similarity between descriptor sets increase in number, and thus, the recognition speed may also need to be increased exponentially, the hash table may be configured in advance during image learning in an embodiment of the present invention. Descriptors are represented in binary string vectors. Thus, the image matcher 50 may quickly calculate the hash key by selecting a value at a predetermined string position.

In an embodiment of the present invention, the hash key value may be selected as the number of “1's” searched for from a number of predetermined positions selected from the binary string vector. In this embodiment of the present invention, with differing positions and order in which to select the bit value “0” or “1” in the binary string vector, various hash tables may be configured.

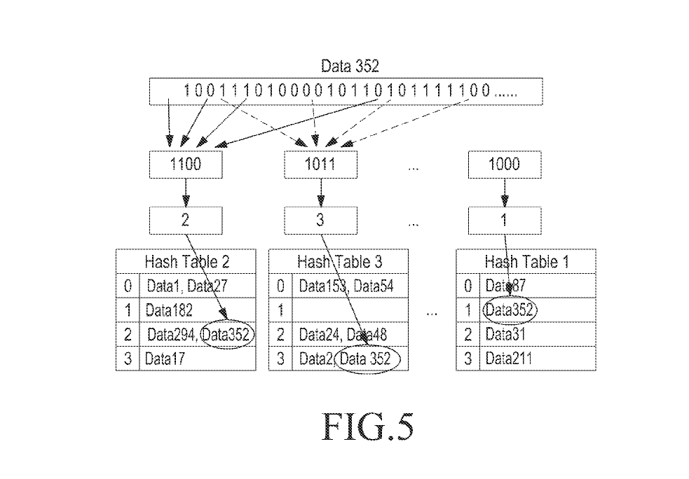

FIG. 5 illustrates hash tables with a plurality of hash keys generated from descriptors, according to an embodiment of the present invention.

Once the hash tables are configured as shown in FIG. 5, the image matcher 50 performs the following operations to find out the most similar feature point to a given feature point.

1) Describing the feature point as the binary string vector.

2) Obtaining a hash key from the described binary string vector.

3) Obtaining all data stored in buckets in which the hash key obtained in 2) is stored, a descriptor for the given feature point, and the Hamming distance.

4) Selecting a feature point having the shortest Hamming distance less than a predetermined threshold.

The feature point selected in operation 4) is the most similar feature point to the query feature point, the feature point of query data.

In another embodiment of the present invention, by eliminating wrong-matched pairs of feature points between the first and second image patches, an error of geometrical matching between the first and second image patches may be minimized.

Referring to FIG. 5, feature data ‘352’ is represented as binary data “100111010000101101011100 . . . ”. The image matching apparatus 100 extracts arbitrary feature vectors 1100, 1011, . . . , 1000 from the binary data. Once the arbitrary feature vectors are extracted, the image matching apparatus 100 may configure hash tables using the feature vectors. Thus, the feature data ‘352’ may be determined to be data corresponding to ‘2’ in Hash Table 1, ‘3’ in Hash Table 2, . . . , and ‘1’ in Hash Table N.

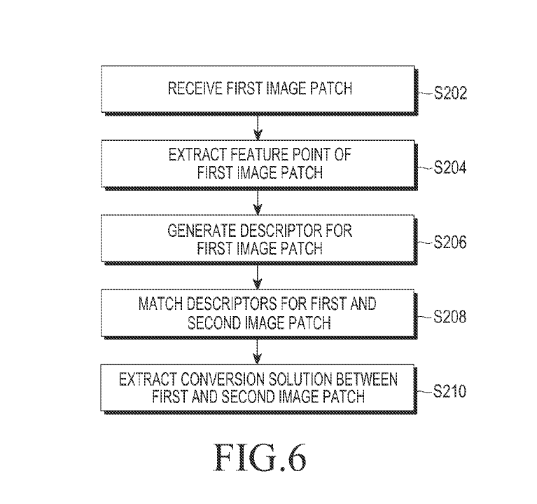

FIG. 6 is a flowchart illustrating an image matching method in the image matching apparatus 100 of FIG. 1, according to an embodiment of the present invention.

Referring to FIG. 6, the image input unit 10 of the image matching apparatus 100 receives a first image or a first image patch included in the first image, in step S202. Once the first image patch is received, the feature extractor 20 extracts at least one feature point corresponding to the first image patch, in step S204. In an embodiment of the present invention, the feature extractor 20 may extract the feature point regardless of changes in rotation and size of the first image patch. In another embodiment of the present invention, the feature extractor 20 may extract feature points corresponding to respective image patches using a FAST corner point extractor.

Once the feature point of the first image patch is extracted, the descriptor generator 30 generates a descriptor for the first image patch, in step S206. In an embodiment of the present invention, the descriptor generator 30 may generate the descriptor by performing rotation normalization on the first image patch.

The image matcher 50 matches the first image patch and the second image patch by comparing the descriptor for the first image patch with any other image, for example, a descriptor for the second image patch, in step S208. By doing this, the image matcher 50 knows of a matching relationship between the first image patch and the second image patch. The second image patch may be an image stored in the memory 40 in advance, an image input to the image matching apparatus 100 before the first image patch is input to the image matching apparatus 100, or an image input to the image matching apparatus 100 after the first image patch is input to the image matching apparatus 100.

In an embodiment of the present invention, the image matching apparatus 100 may extract a geometric conversion solution between the first and second image patches using the matching relationship between the first and second image patches, in step S210.

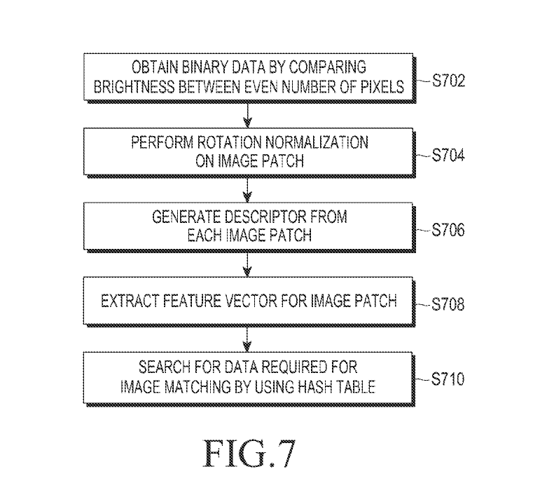

FIG. 7 is a flowchart illustrating an image matching method in the image matching apparatus 100 of FIG. 1, according to another embodiment of the present invention. In an embodiment of the present invention, descriptors generated by the image matching apparatus 100 may be generated after rotation normalization of image patches. Thus, the image matching apparatus 100 may first perform the rotation normalization on, e.g., each of image patches included in the first image and then generate descriptors corresponding to the respective image patches.

Referring to FIG. 7, the descriptor generator 30 obtains binary data by comparing brightness between an even number of pixels centered at a feature point, in step S702. As such, the binary data obtained by the descriptor generator 30 may be the ‘descriptor’ of this embodiment of the present invention.

The descriptor generator 30 compares brightness between an even number of pixels located on left and right positions centered around at least one feature point included in the image patch. The binary data, which is the descriptor, obtained in step S702, may be a value of difference in brightness between the even number of pixels.

In an embodiment of the present invention, the descriptor generator 30 may rotate the even number of pixels to compare the brightness between the even number of pixels. In which case, the image patch does not need to be rotated in a predetermined reference orientation.

In step S704, the descriptor generator 30 performs the rotation normalization on an image patch, e.g., the first image patch included in the first image, centering around at least one feature point. In an embodiment of the present invention, the descriptor generator 30 may normalize an orientation of each image patch by rotating the at least one feature point that corresponds to each image patch.

Once the orientations of image patches are normalized, the descriptor generator 30 generates a descriptor from each of the image patches, in step S706. With the generated descriptor, the descriptor generator 30 may extract feature vectors for the image patch by obtaining the number of “1's” after performing an XOR operation between binary streams using the Hamming distance, in step S708.

In an embodiment of the present invention, the descriptor generator 30 may generate the descriptor in the binary stream form, and thus implement the feature vector in the binary stream form as well.

The image matcher 50 generates hash tables using the feature vectors. Also, when receiving the query data, the image matcher 50 searches data required for image matching by using the hash tables, in step S710.

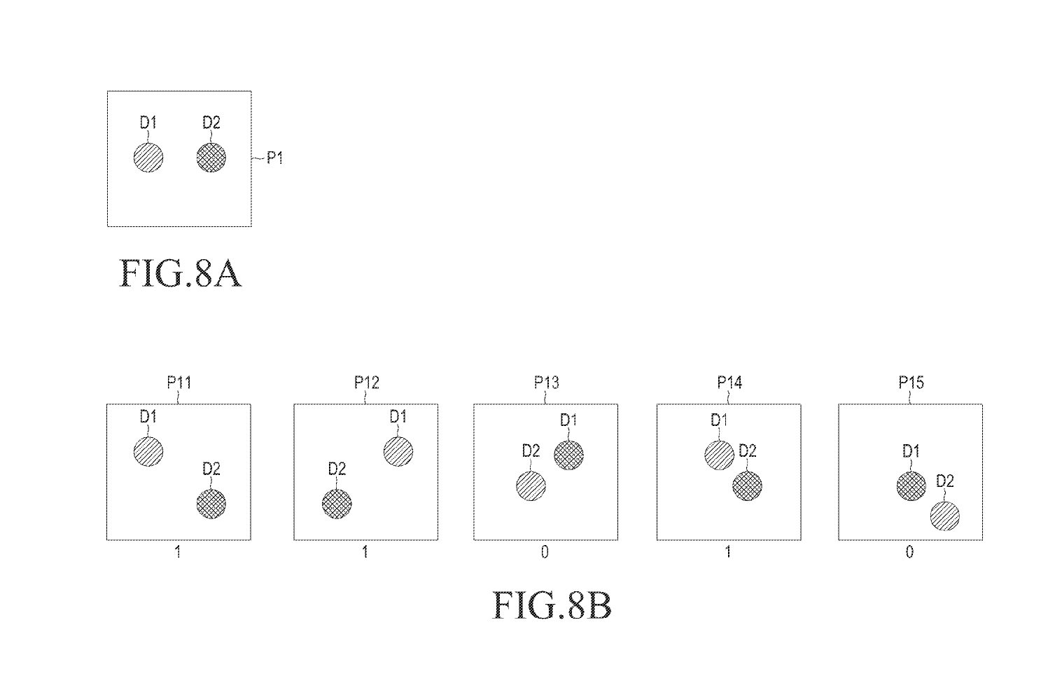

FIGS. 8A and 8B illustrate image patches with which to generate a descriptor in the image matching apparatus 100 of FIG. 1, according to an embodiment of the present invention. FIGS. 8A and 8B show patches used to obtain the descriptor when there is one pixel per group.

If the feature extractor 20 extracts the feature point in the image patch extracted from the first image, the descriptor generator 30 generates descriptors for the image patches. The descriptor generator 30 may obtain binary data, the descriptor for the feature point by comparing brightness between two points in the image patch and representing the comparison result as a binary number.

In an embodiment of the present invention, the descriptor generator 30 compares brightness between two points (first dot D1 and second dot D2) centered around a feature point in an image patch P1 of FIG. 1 and represents the comparison result as a binary number. If the first dot D1 is brighter than the second dot D2, the comparison result comes to ‘1; and if the first dot D1 is darker than the second dot D2, the comparison result comes to ‘0’. The foregoing scheme of obtaining the binary number is expressed in Equation (6) below.

f(x)=0, if I(first dot)>I(second dot)

f(x)=1, otherwise, (6)

In FIG. 8B, different reference numerals are provided for respective image patches P11, P12, P13, P14, and P15 for convenience of explanation, but all the image patches P11, P12, P13, P14, and P15 are the same as the image patch P1 of FIG. 8A. FIG. 8B illustrates a case where the image patch P1 is 5 dimensional.

Referring to FIG. 8B, in the image patch P11, since the first dot D1 is brighter than the second dot D2, the descriptor generator 30 obtains the binary number ‘1’ for the image patch P11. Also, in the image patch P12, the first dot D1 is brighter than the second dot D2, and so the binary number for the image patch P12 is ‘1’. In the image patch P13, the second dot D2 is brighter than the first dot D1, and so the binary number for the image patch P13 is ‘0’. The first dot D1 is brighter than the second dot D2 in the image patch P14, so the binary number is ‘1’. The second dot D2 is brighter than the first dot D1 in the image patch D15, so the binary number is ‘0’.

A descriptor, which is the binary data, may be a sequence of binary numbers for image patches P11 to P15, which represent brightness values between first and second dots D1 and D2. Thus, the binary data is ‘11010’ for the image patches P11 to P15. Such a process of obtaining the binary data corresponds to a projecting process of the image patch as also described in connection with FIG. 3.

In this regard, the first dot D1 and the second dot D2 in each of the image patches P11 to P15 used for obtaining the binary data may be randomly selected by the descriptor generator 30 based on the feature point.

Although FIG. 8B illustrates a case where there is a single feature point per group, there may be two or more feature points in a group, in which case the descriptor generator 30 may obtain the binary data by using the sum of brightnesses at the feature points. An example of obtaining the binary data using the sum of brightnesses at the feature points was described above with respect to FIG. 3.

Furthermore, although FIG. 8B illustrates 5 binary data, i.e., the 5 dimensional descriptor for the image patch P1, the descriptor generator 30 may use N groups of the image patch P1 where the descriptor is N dimensional. Specifically, the descriptor generator 30 may obtain the descriptor comprised of N binary numbers.

As described above, the descriptor generator 30 needs to consider brightness only at each of two points (D1, D2) in each dimension of the image patch P1. Since the image patch P1 has a value ‘1’ or ‘0’ for each dimension, only a capacity of 1 bit is needed for each dimension of the image patch P1. In an embodiment of the present invention, if the image patch P1 is 256 dimensional, the descriptor generator 30 needs a memory of 256 bits, i.e., 32 bytes only.

If an image input through the image input unit 10 has been rotated, related data might have also changed accordingly. Thus, to obtain the same feature vector even when the image is rotated, the feature extractor 20 may normalize the orientation of the image patch.

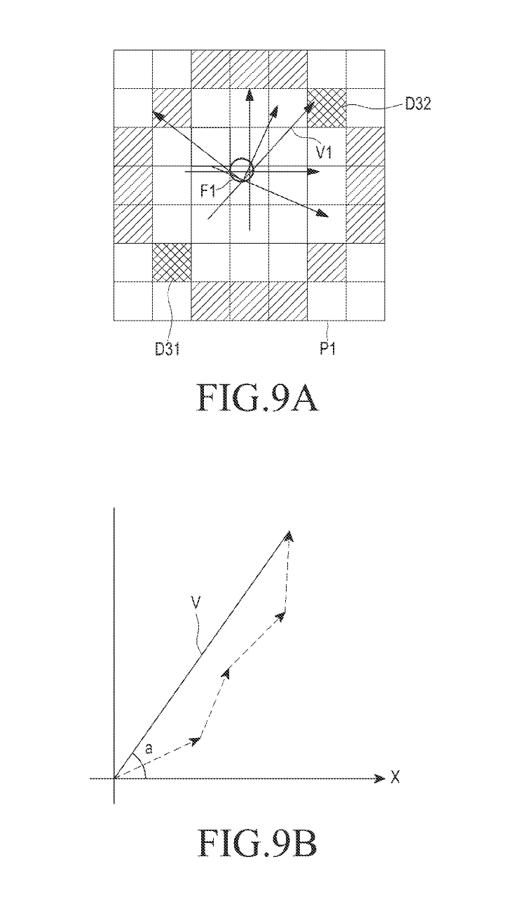

FIG. 9A illustrates an image patch in which m pairs of opposite vectors centered at a feature point are represented in a counterclockwise orientation in order to estimate a dominant orientation of the feature point, according to an embodiment of the present invention. FIG. 9B illustrates how to obtain the dominant orientation of the feature point within the image patch by calculating the sum of m pairs of vectors, according to an embodiment of the present invention.

Referring to FIGS. 9A and 9B, the descriptor generator 30 obtains the m pairs of vectors centered at a feature point F1 in the counterclockwise direction, and obtains an angle of a vector resulting from the sum of m pairs of vectors. Arrows of FIG. 9A represent the m pairs of vectors in an arbitrary manner. In FIG. 9A, the angle of the vector resulting from the sum of m pairs of vectors corresponds to an orientation of the image patch P1. FIG. 9B represents a vector V resulting from the sum of m pairs of vectors, where ‘a’ represents an angle of the vector V.

The m pairs of vectors of FIG. 9A have fixed orientations with different scalars for the image patches P11 to P15. The scalar of each of the m pairs of vectors corresponds to a difference in brightness between two opposite points at the same distance from the feature point F1. Taking as an example the image patch P1 of FIG. 9A, the scalar of a vector V1 corresponds to a difference in brightness between two points D31 and D32 centered at the feature point F1 in the same orientation.

Referring to FIG. 9B, the orientation of the image patch P1 is measured with respect to the X-axis. The descriptor generator 30 may obtain the same descriptors for the entire image, i.e., an image input through the image input unit 10 by rotating the image patch P1 to ensure the orientation of the image patch P1 to correspond to the X-axis no matter what angle the image has been rotated to.

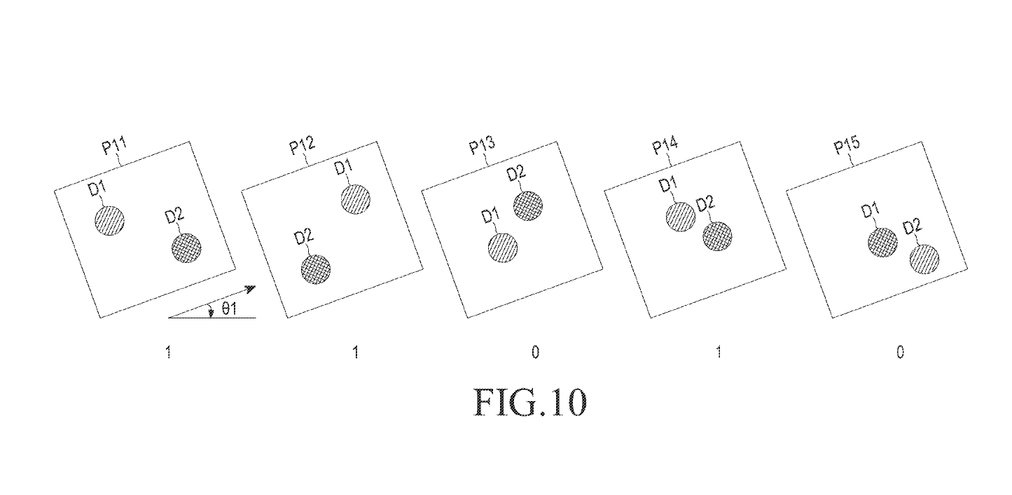

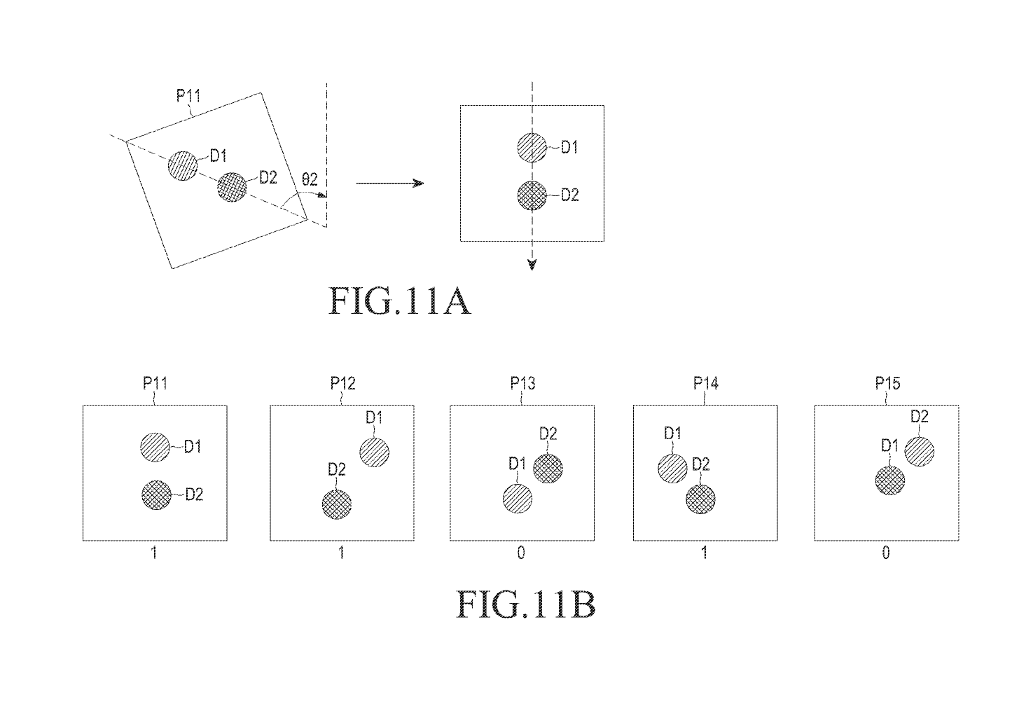

FIG. 10 illustrates a process of obtaining a descriptor that corresponds to a feature point through normalization of an image patch when the angle of the image patch has been calculated as in FIG. 9B. Referring to FIG. 10, image patches P11 to P15 has been rotated by an angle of ‘θ1’. The image matching apparatus 100 may generate descriptors corresponding to the image patches P11 to P15 rotated as in FIG. 6, however, the amount of operations increases significantly in the image matching apparatus 100. In an embodiment of the present invention, the descriptor generator 30 counter-rotates the image patches P11 to P15 as shown in FIGS. 11A and 11B, and then may generate descriptors from the counter-rotated image patches P11 to P15.

FIG. 11A illustrates an image patch being counter-rotated in the opposite orientation of the dominant orientation for rotation normalization of the image patch, according to an embodiment of the present invention. FIG. 11B illustrates positions of points for brightness comparison for image descriptors being relatively rotated instead of rotating the image patch itself, leading to the same effect as in FIG. 11A, according to an embodiment of the present invention. For convenience of explanation, FIG. 11A illustrates counter-rotation of the image patch P11 rotated by an angle of θ1, by an angle of θ2. FIG. 11B illustrates rotation of image patches P11 to P15 rotated by the angle of θ1, by different angles.

As described above in connection with FIG. 8, the descriptor generator 30 represents each descriptor for each image patch P11, P12, P13, P14, or P15 in a binary number. Thus, as shown in FIG. 11B, even if the image patches P11 to P15 are counter-rotated in the opposite orientation of the rotation orientation of FIG. 10, the descriptor generator 30 may generate the same descriptors as those generated by using the rotated image patches P11 to P15 of FIG. 10.

The descriptor generator 30 may rotate the image patches P11 to P15 by different angles.

As shown in FIG. 11B, once a descriptor in a binary string form is generated, the image matcher 50 determines similarity using the descriptor. The image matching unit 50 uses the Hamming distance in the similarity determination. The Hamming distance refers to the number of different letters located on the same position in two strings that have the same length, and the image matcher 50 performs XOR (exclusive) operation on two descriptors in the binary form by using the Hamming distance and then obtains the number of elements having the value ‘1’. An example of determining similarity between descriptors by using the Hamming distance is expressed in Equation (7) below.

∥1011101, 1001001∥_{H}=2 (7)

In an embodiment of the present invention, the image matcher 50 may reduce the frequency of comparison with other images by using a hash key. However, even when the similarity between descriptors is determined using the Hamming distance, each image includes hundreds of descriptors and thus there may be tens of thousands of comparable pairs of descriptors in comparing the image with any other image. Thus, the present invention uses the hash key to reduce the frequency of comparison.

In an embodiment of the present invention, the image matcher 50 may analyze discernability with the feature vector as shown in FIG. 9B before determining the similarity between descriptors with the hash key as described above. Parts of the feature vector for the entire input image in which there is no change in values do not affect anything about discerning one feature vector from another, and thus, may be excluded from elements for generating the hash key.

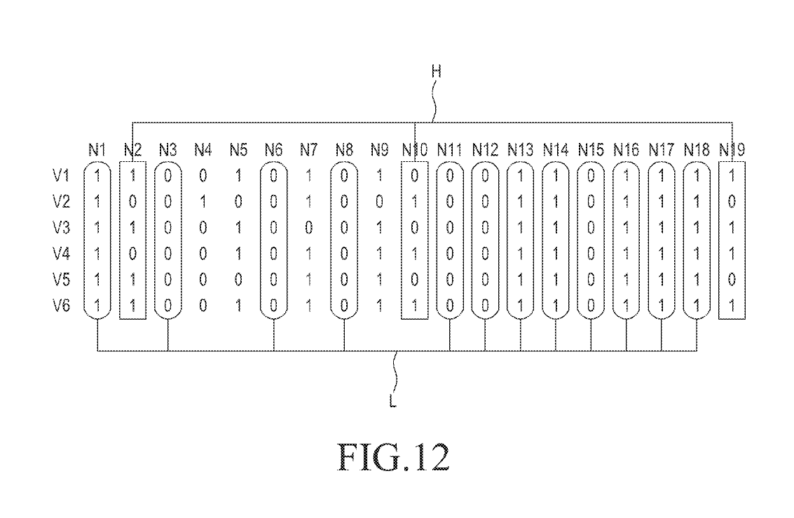

FIG. 12 is a diagram illustrating discernability between feature vectors in the image matcher 50, according to an embodiment of the present invention.

In FIG. 12, descriptors in the binary string form that correspond to respective image patches are arranged on a row basis. Each binary string in each vertical line represents a dimension for configuring a hash table. 19 dimensions are shown in FIG. 12, which are called first dimension N1, second dimension N2, third dimension N3, . . . , and nineteenth dimension N19 from the left.

The image matcher 50 may generate the hash table by arranging descriptors as shown in FIG. 12 and selecting discernible dimensions from among the descriptors that correspond to respective image patches. The image matcher 50 may discriminate high discernible dimensions H and low discernible dimensions L from among the descriptors shown in FIG. 12, and generate the hash table by selecting at least a part of the high discernible dimensions H. In FIG. 12, the low discernible dimension L is overrun with “1's” or “0's”. Thus, the low discernible dimensions L are the first dimension N1, the third dimension N3, the sixth dimension N6, the eighth dimension N8, the eleventh dimension N11, the twelfth dimension N12, the fifteenth dimension N15, the sixteenth dimension N16, the seventeenth dimension N17, and the eighteenth dimension N18. On the other hand, the high discernible dimensions H are the second dimension N2, the tenth dimension N10, and the nineteenth dimension N19.

The image matcher 50 may arbitrarily select at least a part of the high discernible dimensions H. The image matcher 50 generates the hash table using the arbitrarily selected dimensions. Selection of the high discernible dimensions makes data searching speed faster in the matching process between images.

The image matcher 50 randomly selects m dimensions from among M dimensions not to be overlapped in configuring the hash table as shown in FIG. 12. In FIG. 12, the hash table may be configured by only selecting the high discernible dimensions H from among 19 dimensions, i.e., three dimensions N2, N10, and N19.

In an embodiment of the present invention, the image matcher 50 may configure the hash table by selecting the least number of the high discernible dimensions H. For example, the image matcher 50 may configure the hash table by only selecting the second dimension N2 and the nineteenth dimension N19 from among the high discernible dimensions H.

The image matcher 50 uses the number of “1's” in each of the selected dimensions as a hash key. For example, assuming that the second dimension N2 and the nineteenth dimension N19 are selected, hash keys for the second dimension N2 and nineteenth dimension N19 are ‘3’ and ‘4’.

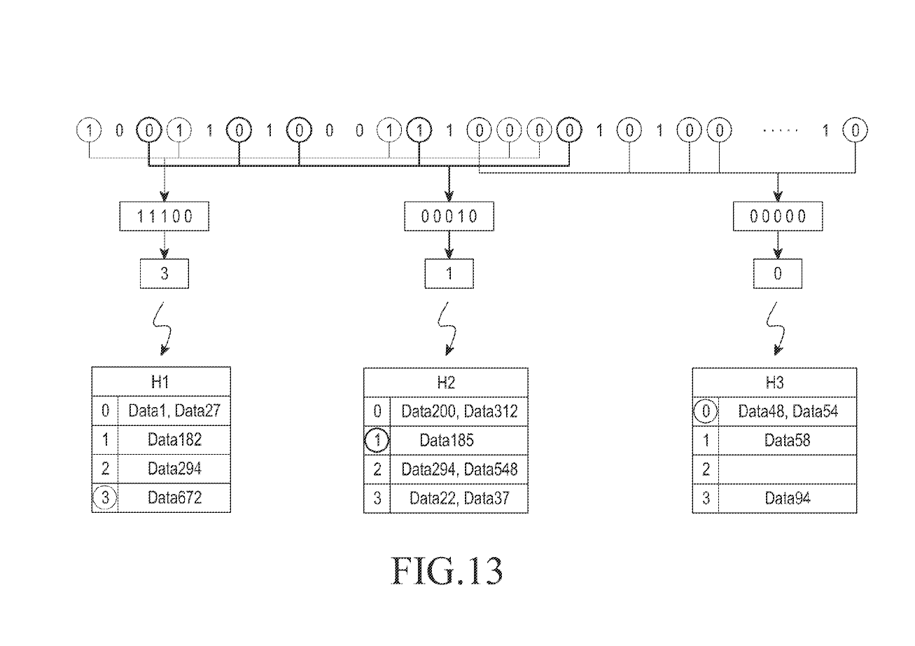

FIG. 13 illustrates an example of data searching with hash keys, according to an embodiment of the present invention.

In FIG. 13, it is assumed that the image matcher 50 uses k hash tables. The image matcher 50 may obtain k hash keys from the k hash tables in data searching. After obtaining the k hash keys from the k hash tables, the image matcher 50 searches data stored in a hash key area of each hash table, and determines the nearest feature vector as the most similar vector.

Three hash tables H1, H2, and H3 are shown in FIG. 13. The image matcher 50 may search the hash tables H1, H2, and H3 with the hash keys. For example, it is assumed that ‘11100’ is randomly selected from within the feature vector shown in FIG. 13. Thus, in FIG. 13, ‘11100’ corresponds to query data. Since the number of “1's” in a vector that corresponds to ‘11100’ is ‘3’, the vector is most similar to a vector for data that corresponds to ‘3’ in the first hash table H1, i.e., ‘Data672’. Similarly, a vector that corresponds to ‘00010’ is most similar to a vector for data that corresponds to ‘1’ in the second hash table H2, i.e., ‘Data185’. A vector that corresponds to ‘00000’ is most similar to a vector for data that corresponds to ‘0’ in the third hash table H3, i.e., ‘Data54’.

As described above, the image matching method of embodiments of the present invention may obtain the descriptor of an image patch in a relatively simple process, thus allowing images to be learned quickly. Furthermore, since fewer descriptors are generated and a logic operator, such as, for example, the XOR operation, is used even in searching, the matching speed of the method may increase rapidly compared with conventional methods.

According to an embodiment of the present invention, the image matching method and apparatus can increase the processing speed by reducing the amount of computation while more clearly representing characteristics of a matched image.

While the invention has been shown and described with reference to certain embodiments thereof, it will be understood by those skilled in the art that various changes in form and detail may be made therein without departing from the spirit and scope of the present invention as defined by the following claims.

What is claimed is:

1. An image matching apparatus comprising:
an image input unit for receiving a first image;
a feature extractor for extracting one or more feature points from the first image;
a descriptor generator for generating one or more descriptors for the first image based on the one or more feature points; and
an image matcher for matching the first image with a second image by comparing the one or more descriptors for the first image with one or more descriptors for the second image.

2. The image matching apparatus of claim 1, wherein the descriptor generator normalizes an image patch having the one or more feature points by rotating the one or more feature points for the first image.

3. The image matching apparatus of claim 1, wherein the descriptor generator obtains feature point descriptors in a binary string form using the one or more feature points.

4. The image matching apparatus of claim 3, wherein the image matcher performs an XOR operation between the feature point descriptors in the binary string form using Hamming distance, and obtains feature vectors for respective image patches included in the first image by counting a number of “1's” included in a value resulting from the XOR operation.

5. The image matching apparatus of claim 4, wherein the image matcher generates a hash table using the feature vectors, and searches data from the hash table for matching the first image with the second image.

6. An image matching method comprising the steps of:
receiving a first image via an external input;
extracting one or more feature points from the first image;
generating one or more descriptors for the first image based on the one or more feature points; and
matching the first image with a second image by comparing the one or more descriptors for the first image with one or more descriptors for the second image.

7. The image matching method of claim 6, prior to generating the one or more descriptors for the first image, further comprising:
normalizing one or more image patches included in the first image.

8. The image matching method of claim 7, wherein normalizing the one or more image patches comprises rotating the one or more feature points within the one or more image patches included in the first image, and
wherein generating the one or more descriptors for the first image comprises obtaining feature point descriptors in a binary string form using the one or more rotated feature points, performing an XOR operation between the feature point descriptors in the binary string form using Hamming distance, and obtaining feature vectors for respective image patches included in the first image by counting a number of “1's” included in a value resulting from the XOR operation.

9. The image matching method of claim 7, wherein generating the one or more descriptors for the first image comprises obtaining feature point descriptors in a binary string form using the one or more feature points, performing an XOR operation between the feature point descriptors in the binary string form using Hamming distance, and obtaining feature vectors for respective image patches included in the first image by counting a number of “1's” included in a value resulting from the XOR operation.

10. The image matching method of claim 9, further comprising generating a hash table by using the feature vectors.

11. The image matching method of claim 10, prior to matching the first image and the second image, further comprising:
searching data from the hash table for matching the first image with the second image.
